(19) United States
(12) Patent Application Publication
(10) Pub. No.: US 2007/0144948 A1
(43) Pub. Date: Jun. 28, 2007

(54) Manual mail sleeve and method for processing manual mail

(75) Inventors: Floyd W. Worth, Richardson, TX (US); Michael O. Norris, Colleyville, TX (US); Dale E. Redford, Grand Prairie, TX (US); James M. Pippin, Keller, TX (US)

Correspondence Address: Siemens Corporation;Intellectual Property Department, 170 Wood Avenue South, Iselin, NJ, 08830, US

(73) Assignee: Siemens Energy & Automation, Inc.

(21) Appl. No.: 11/637,330

(22) Filed: Dec. 12, 2006

Related U.S. Application Data
(60) Provisional application No. 60/754,571, filed on Dec. 27, 2005.

(51) Int. Cl. B07C 5/00; G06K 9/00

(52) U.S. Cl. 209/584; 209/900

(57) ABSTRACT

A method is provided for processing mail at a sorting facility, which mail includes automation mail that can be processed automatically by automated machines at the sorting facility and manual mail which, due to its physical characteristics, cannot be processed by the automated machines at the sorting facility. Such a method includes the steps of placing a piece of manual mail into a sleeve such that the combination of sleeve and mail piece can be processed by the automated machines at the sorting facility, and processing the sleeve containing the manual mail piece on the automation equipment along with automation mail. Following processing, the sleeve can either be removed from the mail piece, or left in place for delivery to the postal customer.

This application claims priority of U.S. Provisional Patent Application Ser. No. 60/754,571, filed Dec. 27, 2005.

### FIELD OF THE INVENTION

This invention relates to postal sorting methods and systems and in particular to the processing of manual mail.

### BACKGROUND OF THE INVENTION

Every day the United States Postal Service (USPS) collects and sorts hundreds of millions of mail pieces and delivers those pieces to over 140 million destinations. Over ninety percent of this mail is sorted using automated equipment and processes. The remaining mail is typically sorted manually by personnel who have scheme knowledge. The cost to sort mail manually is estimated to be ten times greater than to sort mail with automation equipment. For example, manual letter mail can only be sorted by a human at a rate of less than a thousand pieces an hour. In contrast, an automated letter machine can sort mail at a rate of more than thirty thousands pieces an hour. In addition, the personnel used to manually sort mail have to remember memory items and therefore are considered higher skilled workers requiring higher wages.

FIG. 1 shows a simplified view of the manual operations used today to sort manual mail at postal processing centers. The manual sorting cases used in this method require a large area within a processing center to allow segregation of the mail to its many destinations. FIG. 1 illustrates manual mail flow from inputs on the left side of the diagram to manual sort stages as presently practiced at postal facilities using workers that have memorized sort schemes and manually sort mail to bins according to those schemes. Originating manual letter mail refers to collection and mailer mail incoming to the sorting facility that has not been previously processed at another postal sorting facility. Managed manual letter mail refers to manual mail originally sorted at another facility that is being transferred to the current facility. Originating and managed manual flat mail have the same meanings as discussed above, except that the mail pieces are flats rather than letters.

Originating letter mail is first subject to an outgoing primary sort to a limited number of bins, e.g., 70. Some of this mail will need to be transferred to other processing centers or Area Distribution Centers (ADC's). For this purpose, some high volume ADC destinations are assigned a designated bin, whereas lower volume destinations are aggregated to a single bin. Bins which contain mail destined for a single high volume ADC will be dispatched as outbound letters without further sorting. An outgoing secondary sort will be conducted for the letters aggregated during the primary sort, and once so sorted to ADC level, these also are dispatched as outbound letters to another ADC.

In the outgoing primary sort, letters destined for zones within (associated with) that ADC are sorted in a similar manner, with some high volume zones having an assigned exclusive bin, and other lower volume zones aggregated in a single bin. The latter are sent to an incoming primary sort area where they are sorted in combination with incoming managed manual mail received from other centers. The former bypass this stage and are sent directly to the area where the letters are sorted by carrier (the “carrier break” sort stage.)

Flats sorting of originating manual flat mail and managed manual flat mail is conducted in the same way as manual letter mail sorting. Manual flat sorting proceeds in parallel with manual letter sorting and culminates as shown in a flats carrier break sort. The sorted manual mail from both of the carrier break sorts is then combined as each individual postal carrier cases the manual flats and manual letter mail for delivery. This process, being entirely manual and requiring human workers with scheme knowledge, adds considerable expense to the postal sorting process.

It should be noted that “manual mail” for purposes of the invention is a relative term and depends on the nature of the automation equipment in use at a specific facility. There are two general categories of manual mail. The first is classified as “non machinable” due to its physical characteristics. Non machinable mail includes, but is not limited to, mail that is too large, too small, too flimsy, too rigid, not rectangular in nature, unsealed bi folds and tri folds, loose bound edge booklets and pamphlets, loose plastic packed, and mail with items inserted within it such as pens, jewelry, coins and etc. The second category is referred to as “non readable”. This mail is typically considered mail which cannot be read by an Optical Character Reader (OCR) or video coding, or has an obscured address or barcode, or incorrect address information.

Folded mail tends to be non-machinable. The problem that arises is that the folded mail is pinched between two belts, and the velocity of these belts is typically not matched perfectly. This creates a shearing action that can destroy the mail piece and create a jam. The USPS subjects certain types of bifold and trifold mail to a tabbing process to improve its machinability. Tabbing machines apply one or two tabs (dots with adhesive on one side) to hold bifold and trifold mail closed. The mailers of these mail pieces would prefer that these items not be “tabbed”, as it makes the mailing difficult to open, thus is perceived as losing its advertising effectiveness. This type of mail is commonly referred to as “church flyers”, as religious organizations typical use this type of mailing as a weekly or monthly newsletter. The use of the tabbers by the USPS is spotty at best, as this equipment is difficult to maintain, requires a special mail flow, and the use of a single tab at the center may not be sufficient to prevent a jam during sorting. Unless there is a large mailing of this type of mail, it is easier for the USPS operations to send this mail to manual sorting.

Tabbing does not help with flimsy mail pieces. The part of the mail piece not in pinch flops about and can snag on a guide, causing damage and a jam. Delivery Bar Code Sorter—Extended Capability (DBCS-EC) machines are intended to run this mail reliably, but this keeps it in the manual mail stream after sorting to carrier. It cannot be incorporated into the Delivery Point Sequence (DPS) run with regular machinable mail because these machines are typically not EC capable. The present invention is intended to solve these problems by allowing processing in the automation mail stream for this type of mail.

The invention provides an alternate method for sorting mail which has been typically considered manual non machinable in the first category, due to its physical characteristics. By placing this kind of mail a sleeve which can run on automation equipment, the current manual operations used today can be significantly reduced. The invention also eliminates the significant amount of space needed for the manual cases, freeing up valuable space within a facility which can be used for more efficient processes using automation.

### SUMMARY OF THE INVENTION

The invention provides a method for processing mail at a sorting facility, which mail includes automation mail that can be processed automatically by automated machines at the sorting facility and manual mail which, due to its physical characteristics, cannot be processed by the automated machines at the sorting facility. Such a method includes the steps of placing a piece of manual mail into a sleeve such that the combination of sleeve and mail piece can be processed by the automated machines at the sorting facility, and processing the sleeve containing the manual mail piece on the automation equipment along with automation mail. Following processing, the sleeve can either be removed from the mail piece, or left in place for delivery to the postal customer.

The invention further provides a mail sleeve and a mail assembly that comprises a sleeved mail piece useable in the foregoing method. Such a mail assembly comprises a generally flat mail piece have a front side bearing address indicia, and a sleeve for transporting the mail piece through mail sorting equipment. The sleeve has at least one open edge through which the mail piece can be inserted and removed, a transparent front side, and a back side that is opaque to infrared light. The mail piece is inserted with its address indicia visible through the transparent front side of the sleeve.

A preferred sleeve configured for transporting a mail piece through sorting equipment according to the invention is configured for transporting a mail piece through sorting equipment and is made from a sheet of transparent plastic as its front side, and a sheet of a material opaque to infrared light as its back side, the front and back sides being joined along at least adjacent two side edges and forming at least one opening through which the mail piece can be inserted and removed. The sleeve may have a machine readable indicia on the front side for identifying sleeved manual mail to the mail processing system, and an elongated opening in the front side positioned for printing a POSTNET bar code on a front face of a mail piece that has been fully inserted against two joined edges of the sleeve. These and other aspects of the invention are discussed in the detailed description that follows.

### BRIEF DESCRIPTION OF THE DRAWINGS

In the accompanying drawing, like numerals denote like elements, and:

FIG. 1 is a flow diagram of manual mail sorting operations as presently used by the USPS;

FIG. 2 is a front view of a manual mail sleeve according to the invention;

FIG. 3 is a front view of a manual mail sleeve according to the invention with mail therein;

FIGS. 4A-4E are a series of diagrams illustrating manual loading of a sleeve according to the invention;

FIGS. 5A-5E are a series of diagrams illustrating manual removal of sleeves according to the invention from trayed mail including both sleeved mail and automation mail;

FIGS. 6A-6D are a series of diagrams illustrating manual removal of sleeves according to the invention from a tray contain sleeved mail only;

FIG. 7 is a schematic top view of an automated sleeve loading machine according to the invention;

FIG. 8 is a partial side view showing loading a sleeve using the apparatus of FIG. 7;

FIGS. 9 to 13 are a series of partial top views showing an insertion sequence using the apparatus of FIGS. 7 and 8;

FIG. 14 is a front view of an alternate manual mail sleeve according to the invention;

FIG. 15 is a side view of the manual mail sleeve of FIG. 14;

FIG. 16 is a rear view of the manual mail sleeve of FIG. 14; and

FIG. 17 is a front view of another alternate manual mail sleeve according to the invention.

### DETAILED DESCRIPTION

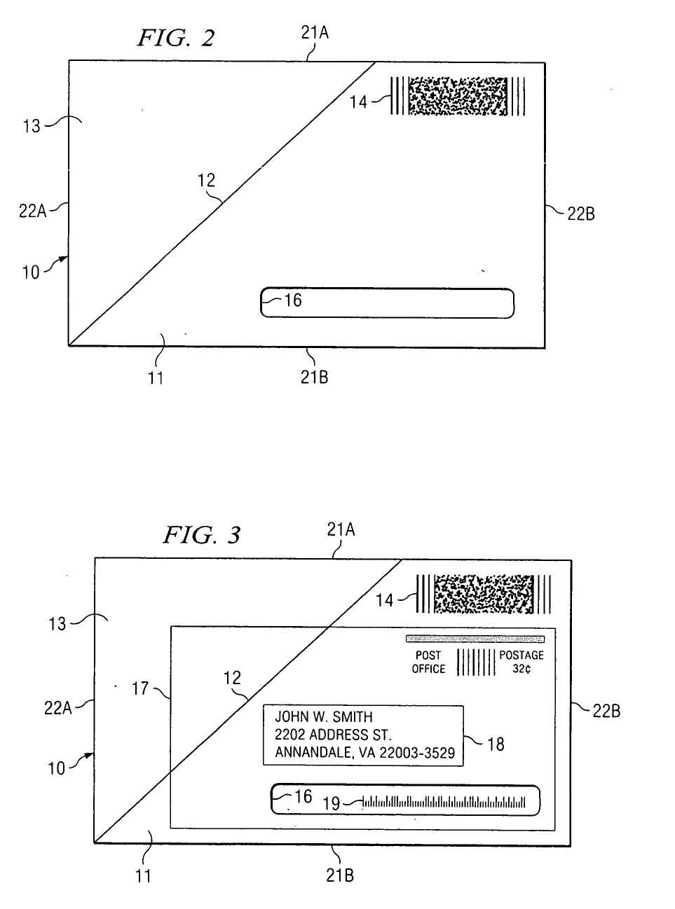

A manual mail sleeve 10 according to the invention is depicted in FIG. 2. The sleeve geometry facilitates the insertion and extraction of the smallest and the largest letter pieces by a manual or automated process. In one embodiment, the front side 11 is cut away at one corner to provide an angled edge 12 so the operator may hold on to the back side material 13 with one hand and the letter to be inserted or extracted with the other hand. The operator simply places the corner of the mail piece with the address facing towards front side 11 and slides the mail piece in between the front and back sides 11, 13. For extraction, the operation is reversed.

The material from which front side 11 is made is preferably transparent to visible light so that cameras and sensors can read the address and barcode indicia that may be printed on the original mail piece. A bar code indicia 14 pre printed on sleeve 10 indicates to the sorting system that this item is a manual mail sleeve and may provide a unique ID number that permits the system to create a data record associated the sleeve with the address information of the mail piece it contains. A cut-out 16 in the form of an elongated rectangle with rounded corners in the front side material allows a POSTNET bar code to be printed through cut-out 16 on the original mail piece.

The back side 13 material is preferably opaque to infrared light. This allows the sleeve to be detected by infrared light barriers used in conventional sorting equipment. The rigidity of the combination of the front- and back side materials is flexible to allow the sleeve and letter combination to be sorted using conventional pinch belt technology as used in the Siemens Delivery Bar Code Sorter (DBCS) series. The invention thereby makes mail which is characterized as too flimsy machinable by inserting that piece into a sleeve thus adding the rigidity required for the combination to be sorted using conventional automation equipment.

FIG. 3 illustrates a mail piece 17 inserted into sleeve 10 the invention. Note that all information on the mail piece, including the delivery address 18, is visible through front side 11 so that the sorting machine sensors can encode the data. Also per the example, the POSTNET bar code 19 is printed on the mail piece 17 through cut-out 16 which is provided in the POSTNET clear zone. For this purpose, it is strongly preferred that the mail piece 17 be fully inserted into sleeve 17 so that inner end of the mail piece 17 is up against sealed edges 21B, 22B. As an alternative to a cut-out 16, a bar code can be printed directly on the outside of the sleeve, such as by placing a layer of printable material such as a printable ink on the outside of sleeve 10 at the same position as cut-out 16. A similar layer provided on the back of the sleeve would be used to print an ID tag number.

Sleeve 10 can be fabricated from conventional plastic materials. Its dimensions can vary as needed to meet postal requirements, but will preferably be those of the largest mail piece machinable on the sorting systems used, so that a range of different types and sizes of smaller manual mail pieces can be put inside a uniform sleeve. Each sleeve 10 is preferably joined such as by an adhesive along two adjacent edges, one long edge 21B and one short edge 22B in the case of a typical rectangular sleeve, leaving the other two edges 21A, 22A open. A sleeve 10 open only along one edge 21 or 22 could be used, but would be more difficult to load and unload. An edge of the sleeve need not be open along its entire length to be considered open for purposes of the invention, so long as the open portion is long enough to permit insertion and possible removal of a mail piece from the sleeve. An adhesive such as one or more areas or spots of a weak, releasable contact adhesive may be provided on the inside of sleeve 10. The adhesive can be positioned anywhere effective for holding the mail piece in position without interfering with insertion, and aids in keeping the mail piece in the proper, fully inserted position.

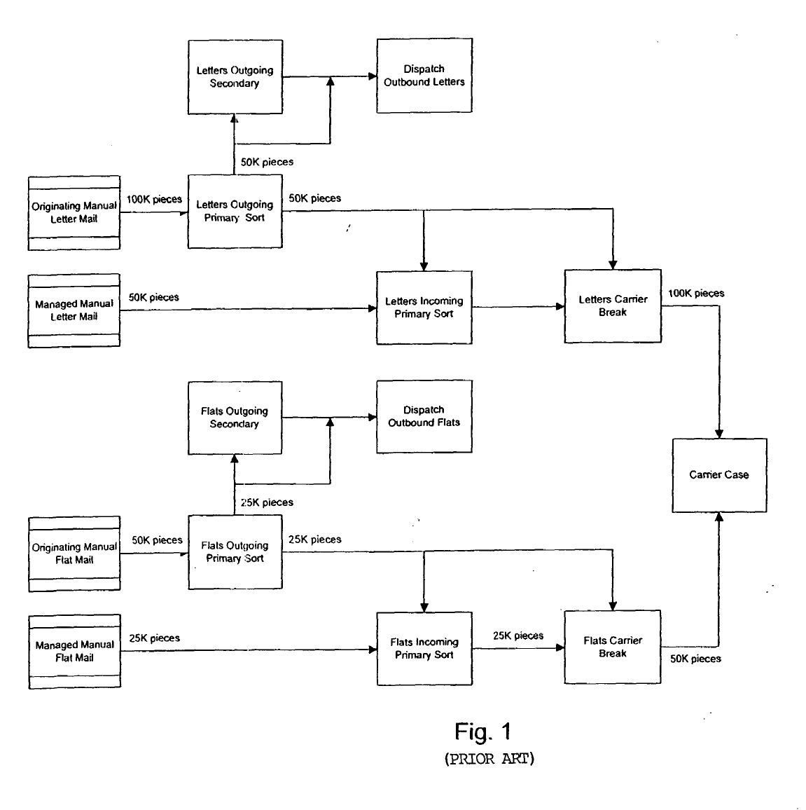

FIG. 1 shows a simplified flow of the present day manual processing of manual mail. As discussed above, the left side represents the inputs to the process. The invention modifies this process by taking the manual mail that has been inserted into a sleeve 10 and has operations that were performed manually now being performed by automation equipment, thus reducing the labor to perform the downstream sortation processes.

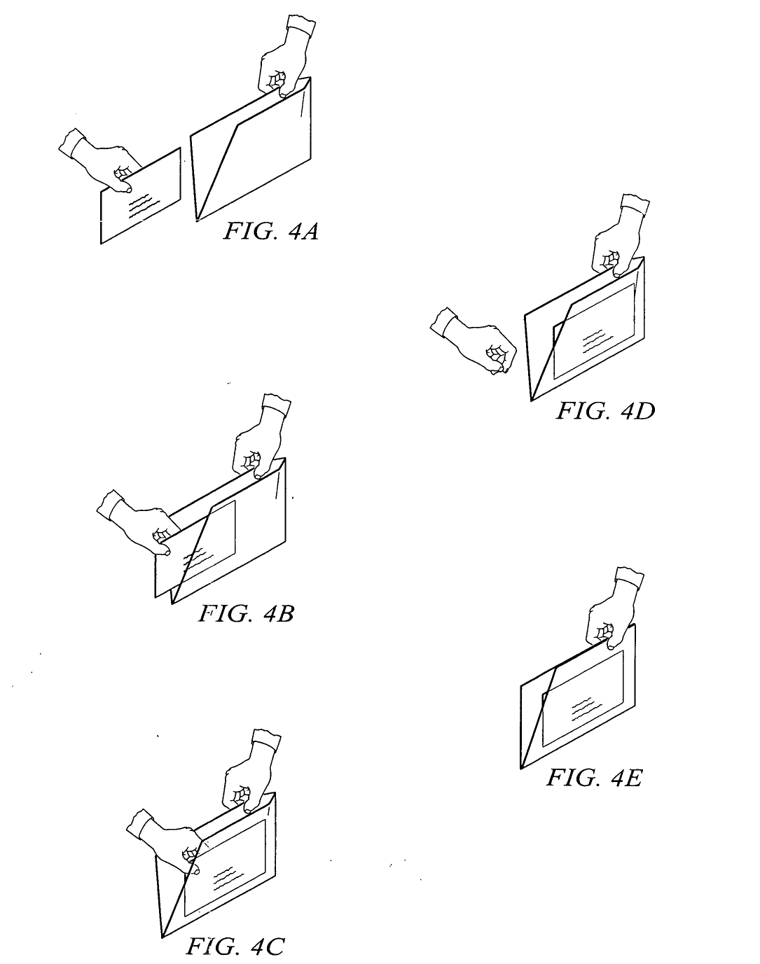

FIGS. 4A-4E illustrate the first operation performed with the manual mail. In steps 1 through 5 shown in FIGS. 4A-4E respectively, an operator inserts mail that has been determined empirically to be manual mail into a sleeve of the invention. The sleeve is then placed into a tray. Full trays containing sleeved mail are taken to the first automation operation depending on the origin of the input. Some trays will be taken to a machine running an outgoing primary sort scheme, whereas other trays will be taken to a machine running incoming primary sort scheme.

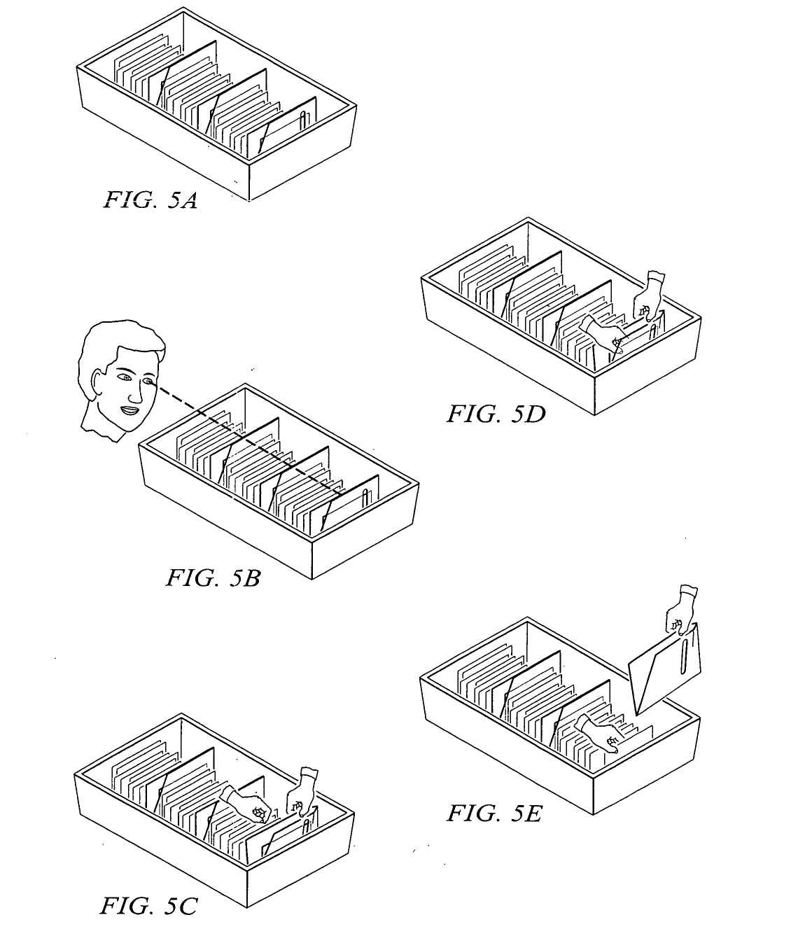

In the preferred embodiment, the sleeved mail will be mixed with the automation mail through all the sorting operations, including two- and three pass delivery point sequencing operations. At that point, the sleeves will be removed while maintaining the letter sequence within a tray. FIGS. 5A-5E show the steps for manual removal of sleeves such as sleeves 10 from mail pieces in a tray. The tray, which contains automation and manual mail, is then taken to the carrier for delivery. The empty sleeves are gathered and readied for the next days' use.

In an alternate embodiment, the sleeved mail and the automation mail are given to the carrier for delivery to the postal customer without removal of the sleeves. The postal customer will have the choice to recycle or disposed of the sleeve. The sleeve may be preprinted with advertising that will be viewed by the postal customer.

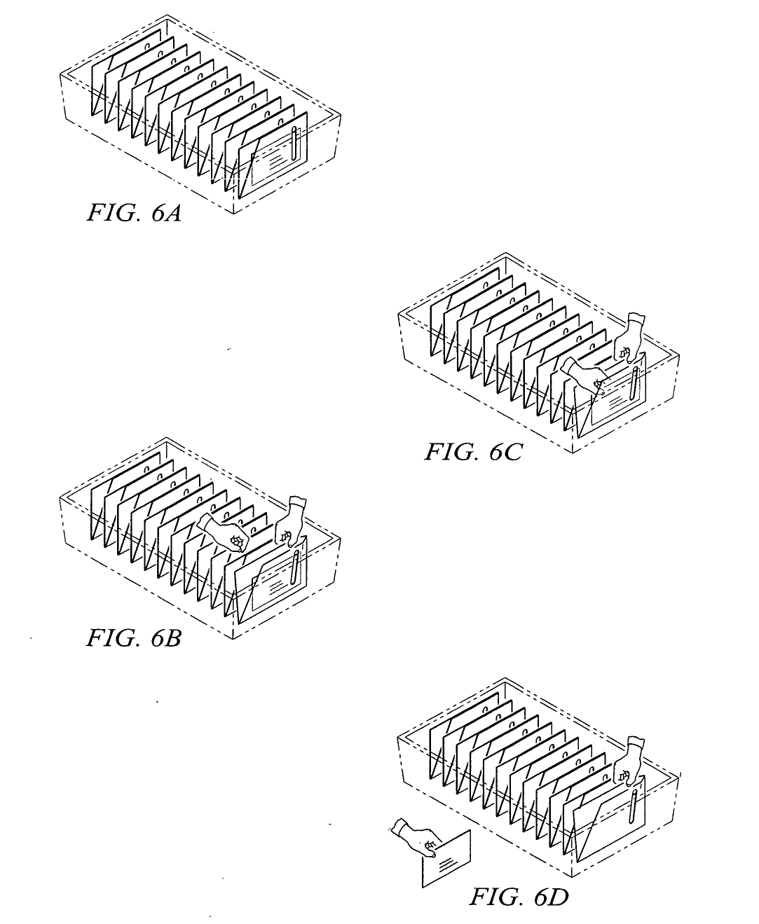

In another alternative embodiment, the sleeved mail remains isolated from the automation mail. In this embodiment, the sleeved manual mail is sorted to the level desired by the local facility. By isolating the sleeved mail, the time for extracting the sleeve from the mail will be faster. For example, in the case where all sleeved mail is sorted to carrier route, the sleeve will be extracted and each carrier will receive a single group of manual mail in a tray. FIGS. 6A-6D show an example where the sleeves remain in the tray and the manual mail is extracted.

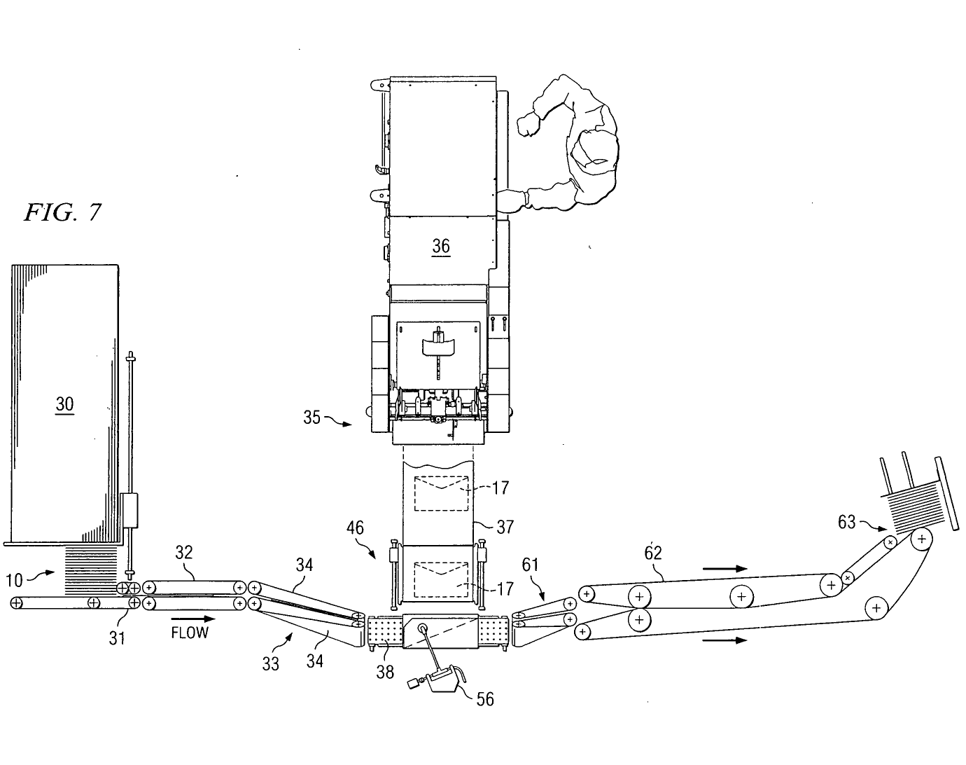

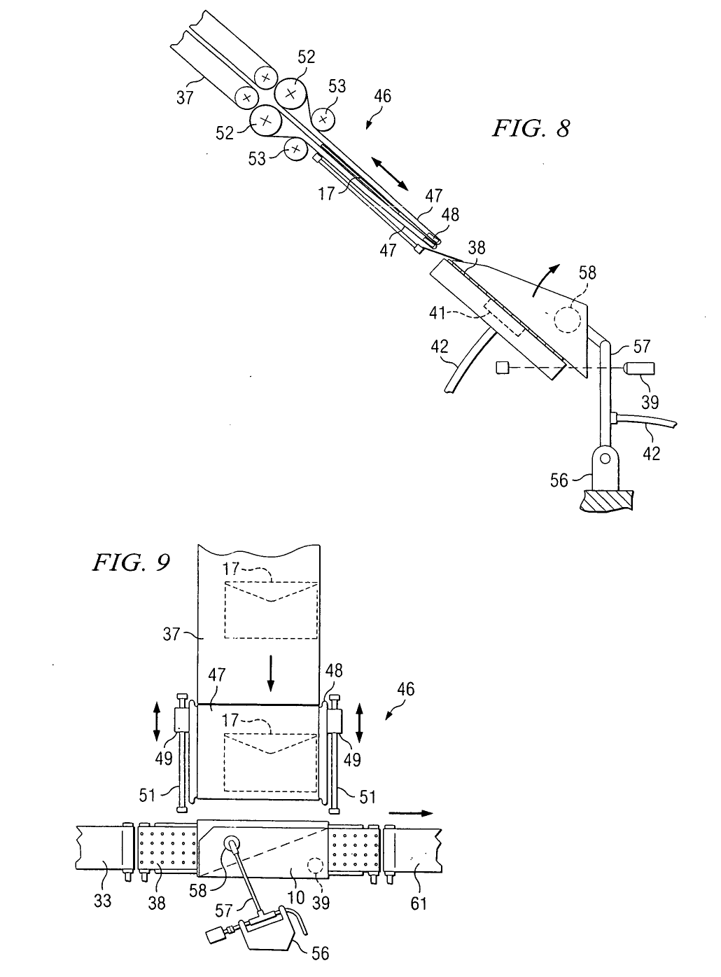

FIGS. 7 to 13 illustrate an automated approach to loading sleeves 10. Empty sleeves 10 are manually loaded stacked on edge, open side up, onto a sleeve feeder 30 that includes a pickoff mechanism 31. Pickoff mechanism 31 feeds the endmost sleeve 10 in a vertical orientation to a pinchbelt conveyor 32. Conveyor 32 terminates in a twister section 33 wherein its belts 34 are angled so that the sleeves are brought to a desired orientation for loading. This may be horizontal or an intermediate angle between horizontal and vertical, such as 45 degrees, with the open side of sleeve 10 opening toward an sleeve loading system 35. Loading system 35 includes a sleeve feeder 36 and an inserter 46. Sleeve feeder 36 may be a known feeder as presently used in binderies for handling of printed advertising. The output from feeder 36 is a series of singulated manual mail pieces 17 transported on a horizontal or angled pinch belt conveyor 37 (FIG. 8). In the alternative to the system shown in FIGS. 7-8, a conventional envelope inserter could be used to load the sleeves, e.g., a Phillipsburg envelope inserter or comparable inserter manufactured by Pitney-Bowes or Bell & Howell, depending on the characteristics of the mail pieces to be loaded. However, presently available envelope inserters are not able to handle a wide range of manual mail types and sizes.

A sleeve 10 exits twister section 33 of the pinch belt conveyor at an angle of about 45 degrees and moves onto a vacuum belt 38. A vacuum manifold 41 connected to a source of negative pressure by a hose 42 applies suction from the underside of belt 38 through holes in belt 38, holding one side of the sleeve 10 against the belt surface. A photocell 39 detects when sleeve 10 is bought into alignment with conveyor 37 so that the loading sequence can begin.

Referring to FIG. 8, mail piece 17 exits conveyor 37 and enters the inserter mechanism 46. Inserter 46 includes a pair of endless pinch belts 47 mounted on respective plates or frames 48, disposed horizontally or at an acute angle as shown in FIG. 8, for example, about 45°. Frames 48 are in turn secured by side brackets 49 to a pair of slide bars 51, enabling the belt and frame assembly 47, 48 to reciprocate along the length of bars 51 under the action of a suitable drive mechanism such as a motor-driven timing belt. Each belt 47 is preferably wound about a pair of rollers including a conventional motorized drive roller 52 and an idler roller 53. Rollers 52, 53 operate during loading of inserter 46 so that the belts 47 move at the same speed and in the same direction as the belts of conveyor 37 to accept the next mail piece to be inserted. These rollers are omitted for purposes of illustration in FIGS. 9-13, but can be mounted at opposite ends to brackets 49.

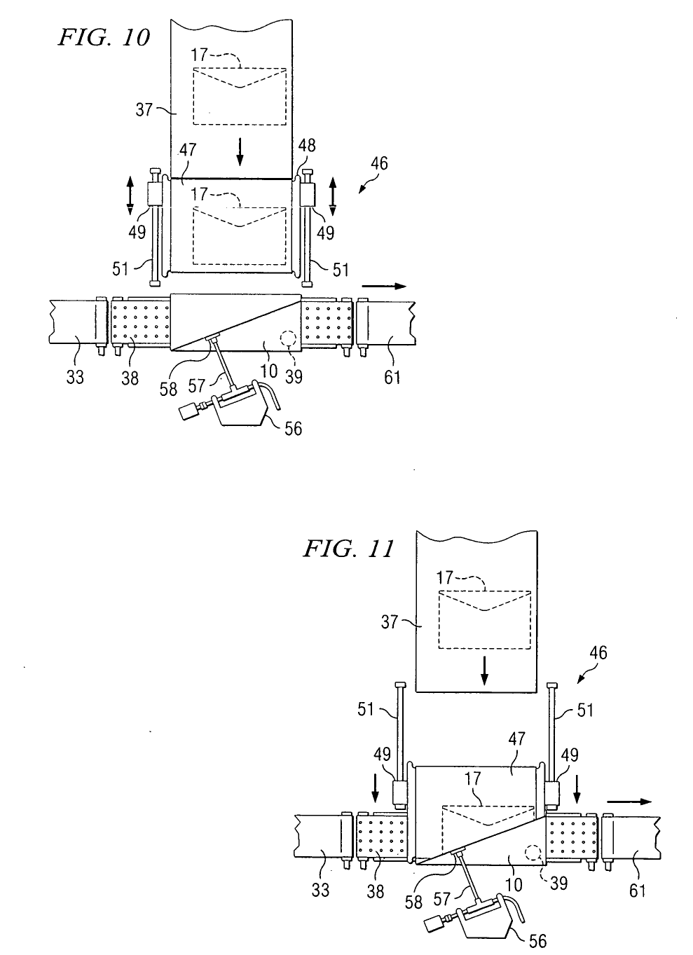

FIGS. 9-13 illustrate a method of loading a series of sleeves 10 with mail pieces 17. A sleeve 10 transported from feeder 30 exits the twister section 33 of the conveyor 32 and is engaged by vacuum belt 38. Belt 38 is driven until the leading edge of sleeve 10 is detected by photocell 39, indicating that the sleeve is in registration with inserter 46. At that point, sleeve 10 is opened by means of a suction cup mechanism 56 including a pivoting arm 57 ending in a suction cup 58. Arm 57 swings into engagement with the outside of sleeve 10 at a suitable location near the upper left corner of its front side 11, adjacent the two open edges. Suction is applied through cup 58, and arm 57 then swings back, lifting front side 11 with it to assume the position shown in FIG. 10.

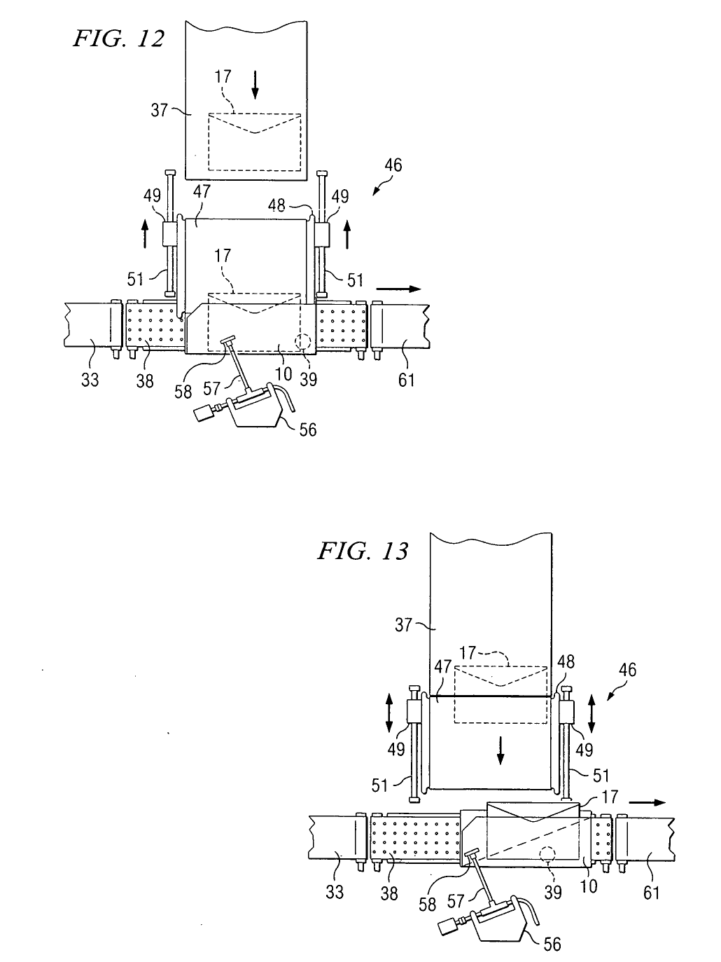

At this stage, insertion mechanism 46 is operated to move brackets 49 to the bottom ends of slide bars 51, causing belts 47 holding a mail piece 17 to move inside of sleeve 10 as shown in FIG. 11. Then, belts 47 are again driven by rollers 52 in the same direction as previously while brackets 49 move back to the top ends of bars 51 as shown in FIG. 12. This causes the mail piece 17 to exit inserter 46 and remain in position at the bottom corner of sleeve 10 as shown. It is preferred that the bottom and one side edge of the mail piece 17 be registered with the corresponding sealed edges of sleeve 10, so that the filled sleeves can be stacked and processed in a uniform manner. If the mail piece is deposited in a random position within the sleeve 10, the machinability of the sleeve-mail piece assembly is reduced, and repeated passage through pressure rollers in a postal sorting machine may gradually push the mail piece out of the sleeve.

Suction through cup 58 is cut off, causing the front side 11 of sleeve 10 to return to its former position. Finally, as shown in FIG. 13, the loaded sleeve 10 is taken away onto a second twister section 61 as another mail piece 17 is loaded into inserter 46, so that the cycle can be repeated for the next sleeve 10. The loaded sleeve is carried on a conveyor 62 similar to conveyor 32 to one end of a stacker 63, where the filled sleeves 10 accumulate in an edgewise stack until the process is complete. This type of system eliminates the need to load the sleeves manually except in the case of misfeeds for which a human operator can intervene.

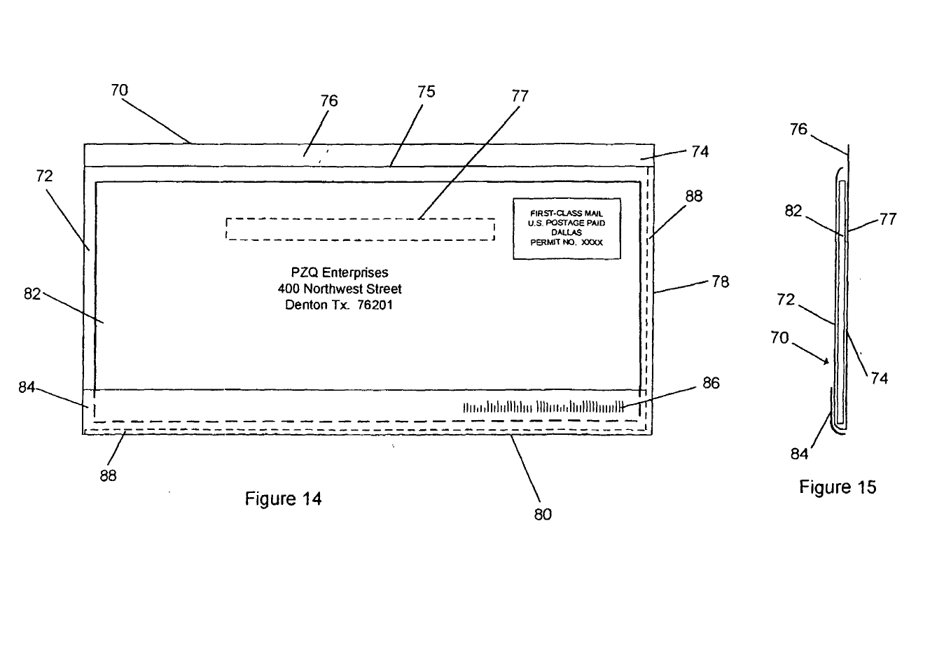

Referring to FIGS. 14-16, an alternate sleeve 70 of the invention has a rectangular transparent front side or cover 72 and a rectangular opaque back cover 74. Front cover 72 is preferably formed from a suitable transparent plastic, whereas back cover 74 may be plastic or paper. Front cover 72 is secured to back cover 74 by gluing or welding front cover 72 to back cover 74 along adjacent short and long sides 78, 80. In a preferred embodiment, back cover is formed from a white paper having sufficient flexibility to allow sleeve 70 to be processed with conventional mail sorting equipment while being sufficiently stiff to support a flimsy mail piece during processing. Sleeve 70 may be manufactured in a variety of sizes to accommodate different mail pieces.

In one variation, front cover 72 is formed from a thin sheet of plastic that is substantially more flexible than back cover 74. This construction allows an operator to grasp sleeve 70 between his or her thumb and fingers and slide front cover 72 to the side with his or her thumb to open the sleeve. Additionally, as shown, back cover 74 extends past the upper edge 75 of front cover 72 to form a handhold portion 76 of the back cover 74. Handhold portion 76 of back cover 74 allows an operator to grasp the back cover of sleeve 70 with one hand while inserting or extracting a mail piece 82 from the sleeve with the other hand. In this manner, manual loading or unloading of sleeve 70 can be easily accomplished.

Front cover 72 of sleeve 70 includes a strip 84 of printable material along the lower edge or side 80 of the cover. Strip 84 may be formed from paper or a printable plastic. Preferably, strip 84 has an opaque white or light colored surface for printing indicia such as POSTNET bar code 86 on sleeve 80. This feature is particularly applicable in the case where sleeve 70 is designed for one time use by the postal service. Further, when used to mail a magazine, brochure or other printed advertisement, bar codes and similar markings may be printed on or applied to strip 84 instead of the cover of the publication.

Sleeve 70 is constructed with a narrow bottom seam 88, allowing the mail piece 82 to be placed close to the bottom of the sleeve as possible. This causes the printable front strip 84 to cover a bar code which may be present on the bottom edge of the mail piece 86. Another option is to make bottom seam 88 as wide as the printable front strip 84 thus elevating the mail piece 82 so that it appears completely in the transparent area of the sleeve. If a bar code is present, it can be read since it is not behind an opaque surface such as the printed strip 84.

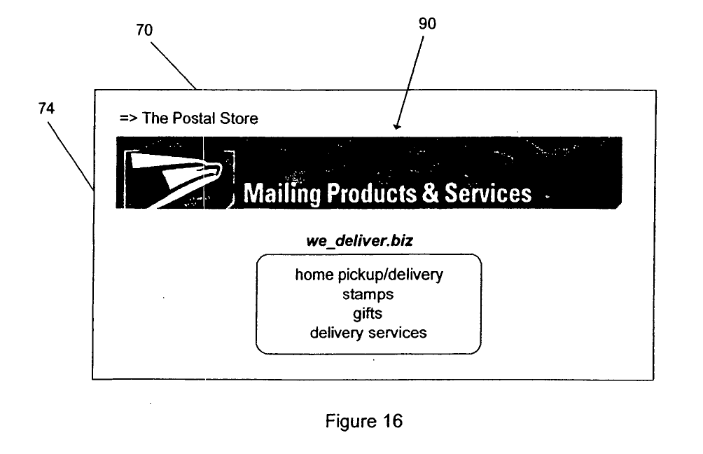

Sleeve 70 may also provide an advertising medium. FIG. 16 illustrates an advertisement 90 printed, for example, on the back surface of back cover 74. When the advertisement is one that a customer would retain for value or informational purposes, such a coupon or business listing, front cover 72 may be attached to rear cover 74 with a seam of releasable adhesive 88 along sides 78, 80. When the customer receives mail in sleeve 70, the customer may then separate front cover 72 from rear 74 and post the rear cover with the coupon or information on a convenient surface such as a refrigerator door.

If back cover 74 is a flat piece of paper having printing on the inside identifying the sender's reply address, this would essentially make it a postcard once the plastic front cover 72 is removed. Back cover 74 could then be used as a business reply mail card. It is important in that case to make sure that the inserted mail 82 covers the printing on the inside of the flat paper backing 74 so that it is obscured when it is originally processed on the mail processing equipment.

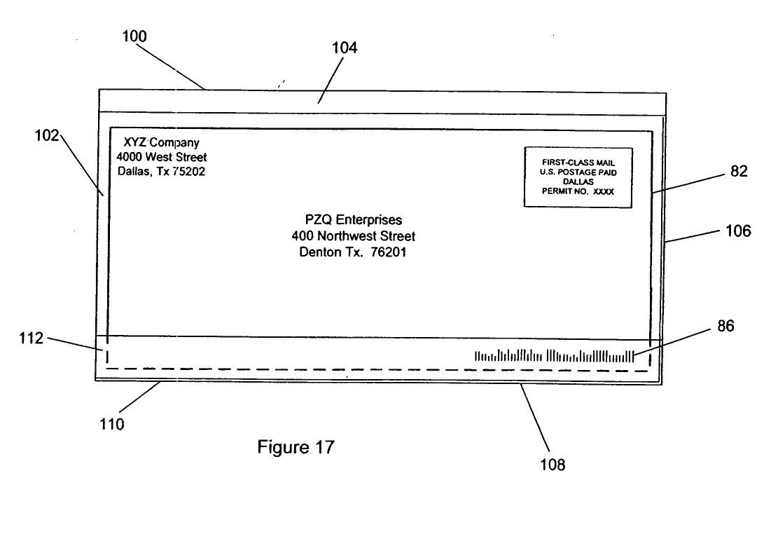

Turning to FIG. 17, in another variation, a sleeve 100 according to the invention includes a transparent plastic front cover 102 and an opaque plastic back cover 104. Sleeve 100 is constructed by welding front cover 102 to back cover 104 along adjacent short and long sides 106, 108 forming weld lines 110. Sleeve 100 is formed with a printable strip or surface 112 along lower edge 108 of the sleeve. Strip 112 may, for example, be made of a white ink suitable for printing on plastic which in turn provides a surface on which a bar code can be printed with conventional equipment. Sleeve 100 is less expensive to manufacture than sleeve 70 while providing substantially the same features and advantages.

Business entities that publish or create magazines, catalogs and brochures often go to considerable expense to design and create these works. Currently, such publications are typically packaged in envelopes or polybags for delivery to selected recipients via a postal services. However, in many instances the brochure or catalog is immediately discarded upon receipt despite the use of high quality paper, elaborate design, layout and expensive reproduction techniques.

Typically, the initial reaction of the customer upon receiving a catalog or brochure in the mail is to decide whether to retain the publication for review or to summarily discard it as he or she sorts through the mail. If the publication is packaged in a difficult to open polybag, the customer is likely to simply discard the unopened bag, particularly if the catalogue or brochure has been rolled or folded to allow for packaging in the polybag. If the cover of the publication is hidden in an envelope, it is more likely to be discarded.

Mail sleeves according to the invention do not suffer the drawback of being difficult to open or of hiding the contents from the recipient until opened. The transparent front cover of the sleeve allows the recipient to view the cover of the publication, so that the use of high quality paper and expensive reproduction methods can have the desired impact on the consumer. Further, the recipient of a brochure, magazine or catalogue delivered in a sleeve can easily remove the publication from the sleeve without tearing open a polybag or opening an envelope.

A further advantage of the mail sleeves of the invention is their range of effectiveness for different types of manual mail. A majority of non machinable mail can become machinable using such sleeves, including mail which is currently tabbed. Instead of sending non-machinable mail to specialized equipment, the mail is routed to one process, which is the sleeving operation, thus simplifying the mail flow. The sleeving operation could be one which inserts each manual mail piece into a preexisting sleeve, or the sleeve could be formed about the mail piece in a sandwiching operation.

A sleeve according to the invention can also be used as a template for determining how a mail piece should be processed. If the mail piece fits inside the template sleeve dimensions, it would be processed on a letter sorter. If the mail piece when placed in the template sleeve is larger than the sleeve, it would indicate the sleeved mail should be processed on a flat sorter.

While this invention has been described with reference to illustrative embodiments, this description is not intended to be construed in a limiting sense. Various modifications and combinations of the illustrative embodiments will be apparent to persons skilled in the art upon reference to the description. Such variations and additions are specifically contemplated to be with the scope of the invention. It is intended that the appended claims encompass any such modifications or embodiments.

1. A mail assembly, comprising:
a generally flat mail piece have a front side bearing address indicia; and
a sleeve for transporting the mail piece through sorting equipment, the sleeve having at least one open edge through which the mail piece can be inserted and removed, a transparent front side and a back side that is opaque to infrared light, wherein the mail piece is inserted with its address indicia visible through the transparent front side of the sleeve.

2. The mail assembly of claim 1, wherein the sleeve has indicia thereon which when scanned by a computerized sorting system indicates to the computerized sorting system that the mail piece is contained within a manual mail sleeve.

3. The mail assembly of claim 1, wherein the sleeve has a cut out in its front side that allows the mail piece to have an indicia printed on it.

4. The mail assembly of claim 3, wherein the cutout has an elongated, generally rectangular shape positioned for printing a bar code when the mail piece is fully inserted into the sleeve.

5. The sleeve in claim 1 which has an adhesive that when pinched secures the mail piece within it.

6. A method for processing mail at a sorting facility, which mail includes automation mail that can be processed automatically by automated machines at the sorting facility and manual mail which, due to its physical characteristics, cannot be processed by the automated machines at the sorting facility, comprising the steps of:
placing a piece of manual mail into a sleeve such that the combination of sleeve and mail piece can be processed by the automated machines at the sorting facility; and
processing the sleeve containing the manual mail piece on the automation equipment along with automation mail.

7. The method of claim 6, wherein the automated machine is a postal sorting machine.

8. The method of claim 7, further comprising removing the sleeve from the manual mail piece when sortation operations are complete.

9. The method of claim 7, further comprising delivering the sleeved manual mail with other mail to a postal customer.

10. A sleeve configured for transporting a mail piece through sorting equipment, comprising:
a sheet of transparent plastic as its front side; and
a sheet of a material opaque to infrared light as its back side, the front and back sides being joined along at least adjacent two side edges and forming an opening through which the mail piece can be inserted and removed.

11. The sleeve of claim 10, further comprising a machine readable indicia on the front side for identifying sleeved manual mail to a mail processing system.

12. The sleeve of claim 10, further comprising an elongated opening in the front side positioned for printing a POSTNET bar code on a front face of a mail piece that has been fully inserted against two joined edges of the sleeve.

13. The sleeve of claim 10 wherein a portion of the back sheet extends beyond an edge of the front sheet which in combination with the back sheet forms the opening through which the mail piece can be inserted and removed.

14. The sleeve of claim 10 wherein the sleeve is rectangular having pairs of long and short sides, and the front sheet further comprises a strip of printable material along an edge of the front sheet along a long side of the sleeve for printing indicia on the sheet.

15. The sleeve of claim 14 further comprising destination indicia printed on the strip of printable material.

16. The sleeve of claim 10 wherein the front cover is joined to the rear cover with a releasable adhesive such that the front sheet may be removed and the back sheet attached to a surface to display information printed on the back cover.
